(19) United States
(12) Patent Application Publication
(10) Pub. No.: US 2008/0004755 A1
(43) Pub. Date: Jan. 3, 2008

(54) Apparatus and method for automatically configuring control of a fan to be exclusively performed by a motherboard

(76) Inventors: Robert A. Dunstan, Forest Grove, OR (US); Scott Lee, Rainier, WA (US)

Correspondence Address: INTEL CORPORATION;c/o INTELLEVATE, LLC, P.O. BOX 52050, MINNEAPOLIS, MN, 55402, US

(21) Appl. No.: 11/477,750

(22) Filed: Jun. 28, 2006

(51) Int. Cl. G05D 23/00

(52) U.S. Cl. 700/299; 700/276; 700/304

(57) ABSTRACT

A method and apparatus are described for automatically configuring control of a fan to be exclusively performed by a motherboard is disclosed. In an embodiment, the motherboard includes remote fan speed control module and a signal module, each to be coupled with a fan over a communication medium. The signal module is to transmit a signal over the communication medium indicating that the remote fan speed control module has exclusive control over fan speed of the fan.

### FIELD

Embodiments of the invention relate generally to thermal control of electronic components. Specifically, the invention relates to using fan speed control to meet thermal and acoustic design goals for a computer system.

### BACKGROUND

As the complexity of computer systems increase, managing heat dissipation becomes more important. The objective of thermal management is to ensure that the temperatures of all components in a system are maintained within their operational temperature range. Operation outside the operational temperature range can degrade system performance, cause logic errors or cause component failure and/or system damage. Temperatures exceeding the maximum operating limit of components may result in irreversible changes in their operating characteristics.

The heat generated by components within the chassis may need to be removed to provide an adequate operating environment for both the processor and other system components. Moving air through the chassis brings in air from the external ambient environment and transports the heat generated by the processor and other system components out of the system.

A heatsink is an example of a passive heat dissipater while 2-wire, 3-wire and 4-wire fans are examples of active heat dissipaters. A 2-wire fan simply has power and ground terminals. A 3-wire fan has power, ground and a tachometer output, which provides a signal with a frequency proportionate to fan speed. A 4-wire fan has power, ground, tachometer output, and a pulse width modulation (PWM) drive input. PWM changes the duty cycle of on-off pulses to adjust the level of power delivered to a motor.

The size and type (passive or active) of the thermal solution and the amount of system airflow can be traded off against each other to meet specific system design constraints including acoustic levels, board layout, spacing, component placement, and structural considerations that limit the thermal solution size. 4-wire fans are well suited to run at a lower percentage of its full speed because of the periodic application of power to the fan motor resulting from PMW signals applied to the PWM input.

Acoustically, fan noise increases directly with fan speed and is a major contributor to total system noise. Meeting acoustic design goals is important because fan noise can be unpleasant for computer system users. One way to reduce acoustic levels is to minimize the fan speeds used to achieve thermal design goals.

Computer motherboards are often available that include thermally based fan control designed to minimize acoustic disturbance without overheating the electronic components on the motherboard.

At the same time, many fans are available with fan-mounted thermistors and circuitry to provide variable fan speed control. Unfortunately, under certain system conditions, fans having thermistors usually override the motherboard's fan control commands by default. Since the commands from the motherboard are overridden, any acoustic benefits that may have been realized are lost.

Where two or more fan control systems (internal or external to the fan) are available to control a fan, system integrators have a need for an inexpensive and efficient way to automatically disable undesirable fan controller functionality.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a block diagram of an embodiment of a system for cooling electronic components including a computer chassis housing a motherboard and cooling fans;

FIG. 2 illustrates a block diagram of an embodiment of a fan control module communicatively coupled with a fan;

FIG. 3 is a flow diagram of an embodiment of a process for transmitting a signal indicating that a remote fan speed control module has exclusive control over fan speed of a fan;

FIG. 4 is a flow diagram of an embodiment of a process for determining that a motherboard has exclusive control over fan speed of a fan;

FIG. 5 illustrates a block diagram of an embodiment of a remote fan controller communicatively coupled with a 4-wire fan.

### DETAILED DESCRIPTION

A method and apparatus for automatically configuring control of a fan to be exclusively performed by a motherboard are disclosed. In the following description, for purposes of explanation, numerous specific details are set forth in order to provide a thorough understanding of the present invention. It will be apparent, however, to one skilled in the art that the present invention can be practiced without these specific details.

In an embodiment, the motherboard includes remote fan speed control module and a signal module, each to be coupled with a fan over a communication medium. The signal module transmits a signal over the communication medium indicating that the remote fan speed control module has exclusive control over fan speed of the fan over the communication medium.

Embodiments include generating a signal to indicate to a fan that a motherboard has exclusive control over fan speed of the fan, and controlling the fan speed of the fan.

In another embodiment, the fan includes or is coupled with a local fan speed control module to be coupled with a motherboard over a communication medium. The local fan speed control module is for controlling the fan speed of the fan. The fan also includes or is coupled with a determination module to be coupled with the motherboard via the communication medium and is for determining whether the motherboard has exclusive control over fan speed of the fan.

Other embodiments include receiving a signal from a motherboard and determining whether the signal indicates that the motherboard has exclusive control over fan speed of the fan.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in an embodiment may be included within other embodiments. The following detailed description is, therefore, not to be taken in a limiting sense, and the scope of the present invention is defined only by the appended claims, along with the full scope of equivalents to which such claims are entitled.

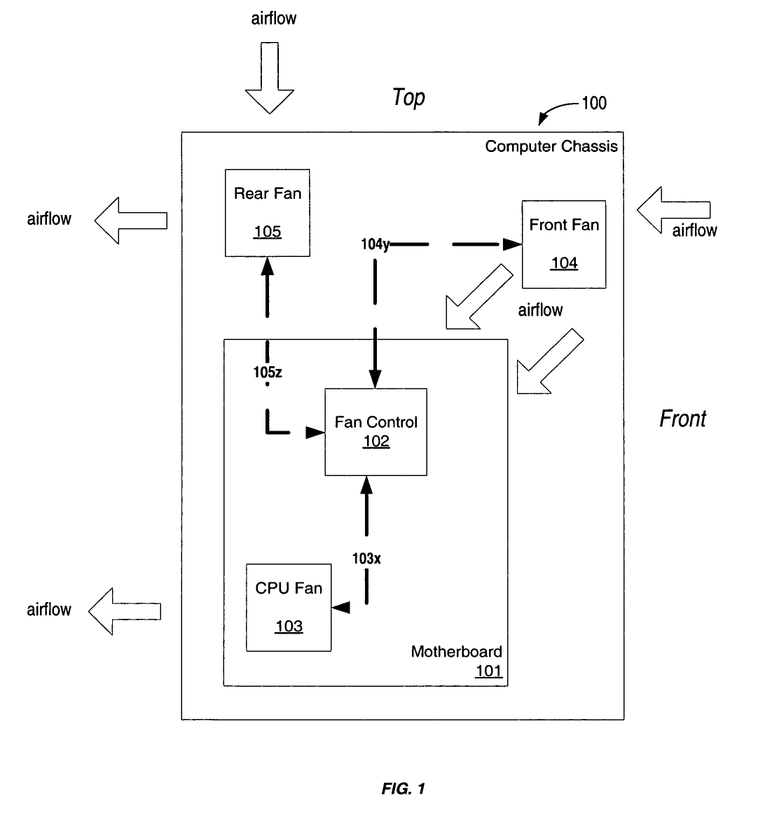

FIG. 1 illustrates a block diagram of an example system for cooling electronic components including a computer chassis 100 housing a motherboard 101 and cooling fans 103, 104, 105.

Computer chassis 100 may be any housing of electronic components. As used herein, a motherboard refers to an entire assembly including a main circuit board, integrated circuits (e.g., central processing unit (CPU), graphics and memory controller hub (GMCH), input/output controller hub (ICH), and other integrated circuits, etc.), memory (e.g., non-volatile and volatile), input/output ports (e.g., small computer system interface (SCSI), peripheral component interface express (PCIe), integrated drive electronics (IDE), universal serial bus (USB), and other I/O, etc.), heatsinks, fans, power supplies and other components mounted or connected to the main circuit board.

Fans 103, 104, 105 may be strategically placed with respect to thermal design considerations to ensure thermal requirements are met for particular electronic components (e.g., to cool the CPU, graphics card, chipsets, power supply, other electronic components, etc.). Fans 103, 104, 105 may include logic (not shown) to provide fan speed control for each respective fan 103, 104, 105 in order to meet target thermal and/or acoustic requirements. In an embodiment, fans 103, 104, 105 include variable fan speed circuitry (e.g., a thermistor to measure temperature and cause a voltage corresponding to the measured temperature to be applied to the fan to affect fan speed).

Fan control for the fan may also include other types of open loop control triggered by measured system temperatures, fan speeds or other system conditions or events, etc. Fan control may also include closed loop control based on system temperature feedback and/or measured fan speed and/or feedback related to other system conditions or events, etc. In an embodiment, CPU fan 103 is incorporated with a heatsink into a cooling device having both active and passive components.

Motherboard 101 includes fan control 102 communicatively coupled via 103x, 104y, 105z with fans 103, 104, 105. Fan control 102 includes logic to provide fan speed control for one or more of fan 103, 104, 105 in order to meet target thermal and/or acoustic requirements. In an embodiment, fan control 102 may be transmits a signal via 103x, 104y, 105z to each of fans 103, 104, 105 to indicate that fan control 102 has exclusive control over fan speed for one or more of fans 103, 104, 105. Fan control 102 may for example provide variable fan speed control (e.g., open loop control) based on temperatures measured within computer chassis 100. In an embodiment, fan control 102 also provides closed loop fan speed control for fan 103, 104, 105 using an indication of the fan speed as feedback. Alternatively or additionally, fan control 102 uses temperature measurements as feedback for providing closed loop control of fan 103, 104, 105 operations. Other types of closed loop feedback control may be used to control the operation of fans 103, 104, 105 based on feedback relating to system conditions such as processor frequency, data transfer, and other metrics, etc.

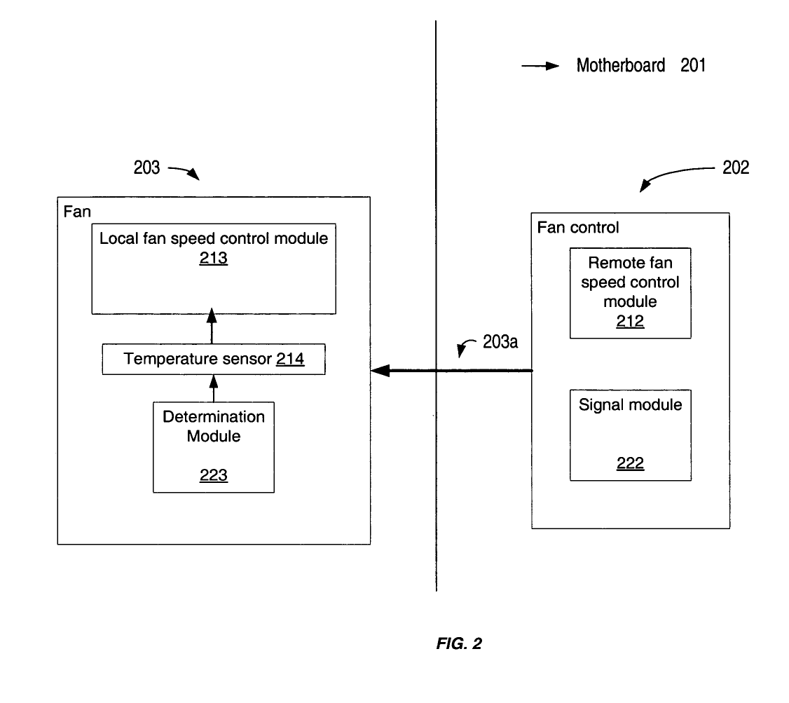

FIG. 2 is a block diagram illustrating embodiments of fan control 202 coupled with fan 203. In the forthcoming description of embodiments, fan 203 may be any one of fans 103, 104, 105 of FIG. 1 and the at least one motherboard 101 may be represented by motherboard 201 of FIG. 2.

In an embodiment, fan control components 202 include a remote fan speed control module 212 and a signal module 222. Remote fan speed control module 212 and signal module 222 represent logic implemented with circuitry, software stored on a computer readable medium to be executed by a processor, or a combination of the two. Remote fan speed control module 212 and signal module 222 are coupled to fan 203, via communication medium 203a. Communication medium 203a is wires coupled between fan 203 and fan control components 202 (e.g., via plugging a male cable connector into a female cable connector), but any communication medium known in the art sufficient to carry the required communications may be used.

In an embodiment, remote fan speed control module 212 drives fan speed of the fan (e.g. by sending PWM signals or applying voltage to the fan) and may use any of the various motion control techniques known in the art (e.g., open loop or closed loop feedback control based on e.g. temperature, position, rpm, or other metrics, etc.).

In an embodiment, signal module 222 delivers a signal via communication medium 203a to indicate that remote fan speed control module 212 has exclusive control of the fan speed of fan 203. The signal may be for example application of a voltage level or a sequence of voltage levels on communication medium 203a that can be sensed and/or deciphered by fan 203. Additionally or alternatively, signal module 222 delivers one or more signals that communicates information related to the control of fan 203 (e.g., that remote fan speed control module 212 has exclusive control over fan 203 during a particular period of time, or under certain conditions). Signal module 222 additionally or alternatively delivers one or more signals to request from fan 203, information related to fan 203.

Thus, an embodiment of a motherboard 202 is disclosed that includes a remote fan speed control module 212 and a signal module 222 each to be coupled with fan 203 via communication medium 203a. Signal module 222 is for transmitting a signal via communication medium 203a that indicates that the remote fan speed control module 212 has exclusive control over fan speed of the fan over communication medium 203a.

In an embodiment, the remote fan speed control module 212 provides closed loop feedback control of the fan 203 based on either temperature feedback, fan speed feedback, or a combination of the two.

In an embodiment, the signal module 222 provides a signal to the fan 203 by applying a logical voltage level to communication medium 203a for a fixed period of time after operating power has been delivered to fan 203 (e.g., less that 100 milliseconds).

Embodiments of the invention disclosed above may enable a reduced fan speed utilizing fan speed control available on the motherboard instead of the fan speed control override provided by the fan.

Referring again to FIG. 2, fan 203 includes local fan speed control module 213, temperature sensor 214 and determination module 223. In an embodiment, local fan speed control module 213 and determination module 223 represent logic implemented with circuitry, software stored on a computer readable medium to be executed by a processor, or a combination of the two.

In an embodiment, local fan speed control module 213 and determination module 223 are coupled with motherboard via communication media 203a (e.g., via plugging a male cable connector into a female cable connector). As disclosed above, communication medium 203a may be wires coupled between fan 203 and motherboard 202. In an embodiment, fan 203 and motherboard 202 are coupled via plugging a male cable connector into a female cable connector, but any communication medium known in the art sufficient to carry the required communications may be used.

In an embodiment, local fan speed control module 213 controls fan speed of the fan (e.g. by applying voltage to the fan motor) using any of the various control schemes known in the art (e.g. open loop or closed loop feedback control each based on e.g. temperature, position, rpm, or other metrics, etc.)

In an embodiment, fan 203 includes a temperature sensor 214 (e.g. a thermistor) to sense the ambient temperature at its location on the fan 203. Temperature information may be used by logic (e.g. circuitry, not shown) within the local fan speed control module 213 to control the fan speed of the fan 203.

In an embodiment, determination module 223 determines whether operating power has been delivered to fan 203 and receives or senses a signal from the motherboard 201 over communication medium 203a. The signal may indicate that the motherboard 201 has exclusive control of the fan speed of the fan 203. The signal to the fan 203 may be for example the application of a voltage level or a sequence of voltage levels to the communication medium 203a that can be sensed by determination module 223. The determination module 223 may sense one or more signals that indicate other information related to the control of fan 203 (e.g. that the motherboard 201 has exclusive control over fan 203 during a particular period of time, or under certain conditions). The determination module 223 may also sense one or more signals that indicate a request for information about the fan 203. In an embodiment, the determination module 223 may include logic to respond to such requests.

Thus, an embodiment of a fan 203 is disclosed including, a local fan speed control module 213 to be coupled with a motherboard 201 via a communication medium 203a and to control the fan speed of the fan 203. Fan 203 also includes a determination module 223 capable of being communicatively coupled with the motherboard 201 via the communication medium 203a and to determine whether the motherboard 201 has exclusive control of fan speed of the fan 203.

In an embodiment, determination module 223 disables local fan speed control module 213 from controlling fan speed of the fan 203 if motherboard 201 is selected to control fan speed of the fan 203. Conversely, determination module will enable local fan speed control module 213 to control fan speed of the fan 203 if motherboard 201 is not selected to control fan speed of the fan 203.

In an embodiment, determination module 223 senses the voltage level on the communication medium 203a for a fixed period of time after operating voltage has been applied to the fan 203 to determine that motherboard 201 has exclusive control of fan speed of the fan 203 based on the voltage level.

In an embodiment, fan 203 further includes a temperature sensor 214 coupled with determination module 223 and local fan speed control module 213. Temperature sensor 214 is to cause a fan speed of the fan 203 that depends upon the ambient temperature measured by the temperature sensor 214. In this embodiment, determination module 223 is adapted to disable temperature sensor 214 when motherboard 201 is selected to exclusively control fan speed of the fan 203.

When fan speed control that provides a lower limit on fan speed is available on the motherboard, embodiments of the invention disclosed may enable reduced fan speed by disabling default fan speed control provided by the fan. As a result, lower acoustic levels may be realized.

Other embodiments of the present invention can be accomplished by way of software. For example, in some embodiments, the present invention may be provided as a computer program product or software which may include a machine or computer-readable medium having stored thereon instructions which may be used to program a computer (or other electronic devices) to perform a process according to the present invention. In other embodiments, processes of the present invention might be performed by specific hardware components that contain hardwired logic for performing the processes, or by any combination of programmed computer components and custom hardware components.

In an embodiment, the software used to facilitate the routine can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

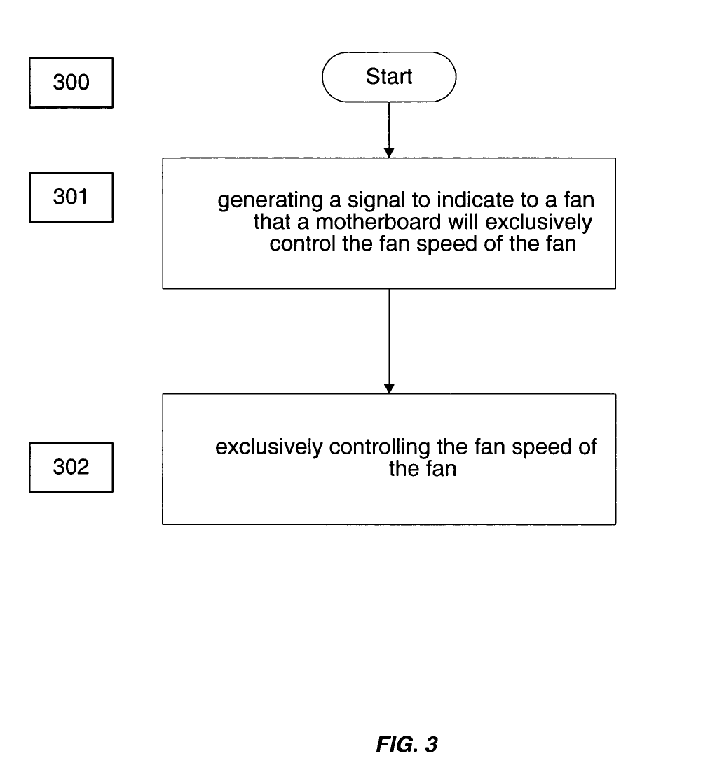

FIG. 3 is a flow diagram of an embodiment of a process 300 for notifying a fan that fan control will be provided by a motherboard. The signal module 222 and the remote fan speed control module 212 may perform the process with processing logic that may comprise hardware (e.g., circuitry, dedicated logic, programmable logic, microcode, etc.), software (such as that run on a general purpose computer system or a dedicated machine), or a combination of both.

In FIG. 3, process 300 starts with processing logic generating a signal to indicate to a fan that a motherboard has exclusive control of the fan speed of the fan (processing block 301). Processing block 301 may be performed by signal module 222 of FIG. 2. Processing logic then concludes process 300 by controlling the fan speed of the fan (processing block 302). Processing block 302 may be performed by remote fan speed control module 212 of FIG. 2.

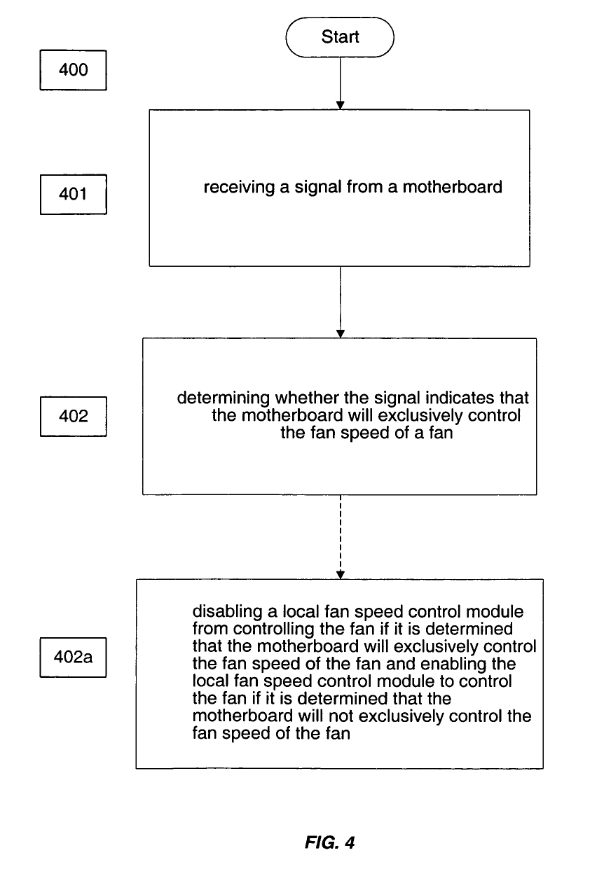

FIG. 4 is a flow diagram of an embodiment of a process 400 for disabling a fan's fan control when fan control is provided by a motherboard. The determination module 223 may perform the process by processing logic that may comprise hardware (e.g., circuitry, dedicated logic, programmable logic, microcode, etc.), software (such as that run on a general purpose computer system or a dedicated machine), or a combination of both.

In FIG. 4, process 400 starts with processing logic receiving a signal from a motherboard (processing block 401). Processing logic may then conclude process 400 by determining whether the signal indicates that the motherboard has exclusive control of the fan speed of a fan (processing block 402).

In an embodiment, process 400 is continued in a sub-process by disabling a local fan speed control module from controlling the fan if the motherboard is selected to exclusively control the fan speed of the fan and enabling the local fan speed control module to control the fan if the motherboard is not selected to exclusively control the fan speed of the fan (processing block 402a).

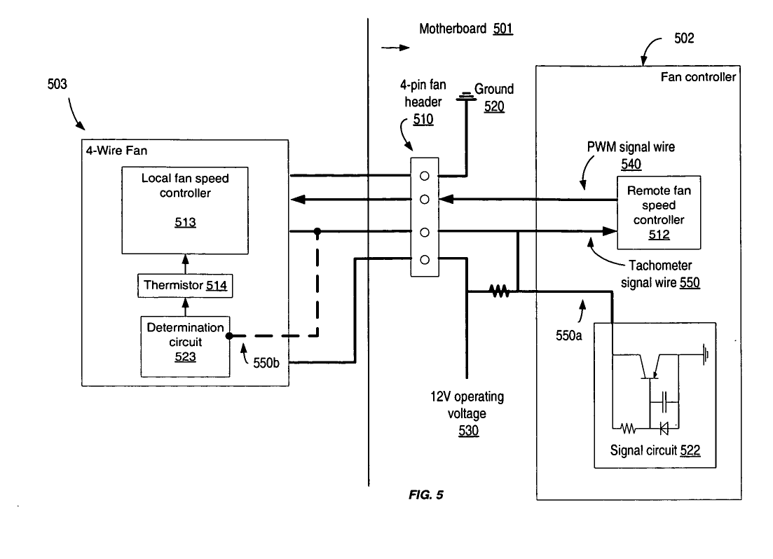

FIG. 5 is a block diagram of an embodiment of a 4-wire fan 503 coupled with a fan controller 502 via a 4-pin fan header 510. An example 4-wire fan and connector may be found in the Intel Corporation specification entitled, 4-Wire Pulse Width Modulation (PWM) Controlled Fans, Rev. 2, 2004

In the forthcoming description of embodiments, fan 503 may be any of fans 103, 104, 105 of FIG. 1 and motherboard 101 may be represented by motherboard 501 of FIG. 5.

Referring to FIG. 5, fan controller 502 includes a remote fan speed controller 512 and a signal circuit 522. Remote fan speed controller 512 and signal circuit 522 are coupled to the 4-wires of the 4-wire fan 503 with a 4-pin header 510. A 4-pin header may be a female cable connector to receive a male connector from the 4-wire fan 503.

4-wire fan 503 includes one wire for ground 520 and one wire to provide 12V operating voltage 530 to the fan 503 for power. A third tachometer output wire 550 provides tachometer output from fan 503 that represents the revolutions per minute (RPMs) of the fan motor. The fourth PWM signal wire 540 delivers pulse width modulation signals to circuitry on fan 503 (not shown). The circuitry on or coupled with fan 503 may cause voltage to be applied to the fan 503 having a duty cycle corresponding to the PWM signals. 4-pin header 510 may also be capable of receiving a connector from a 3-wire fan, and applying 12V operating voltage 530 and ground 520 required to power a 3-wire fan.

Remote fan speed controller 512 is an integrated circuit that provides closed loop control of fan speed based on tachometer feedback. Tachometer feedback is delivered via tachometer output wire 550 and represents the rotational speed of the 4-wire fan 503 motor. More specifically, one or more “contact closure” pulses are conveyed over tachometer signal wire 550 per revolution to fan controller 502. As such, tachometer signal wire 550 is held high by a resistor to 12V so that as the fan is powered, the tachometer pulses come up with the fan's power. The remote fan speed controller 512 also provides variable speed control of the 4-wire fan 503. The duty cycle of the PWM signal is related to temperature readings provided to the remote fan speed controller 512 by one or more temperature sensors dispersed throughout the environment being thermally controlled (sensors not shown)(e.g. an on-die thermal diode in the CPU and a thermistor located adjacent to the MCH on the motherboard). In other words, the fan speed of the 4-wire fan 503 is made to vary based on temperature to create sufficient airflow to satisfy system thermal requirements.

Signal circuit 522 uses a resistor-capacitor (RC) delay circuit to hold voltage low (e.g. 0V) on the tachometer output wire 550 for 20-100 milliseconds after 12V operating voltage 530 has be applied to the 4-wire fan 503 by motherboard 501. Any electrical circuit known in the art conforming to design constraints may be used to hold the voltage low. In an embodiment, an open drain field effect transistor (FET)) is used to hold the voltage low. A low voltage on the tachometer output wire 550 is a signal 550a to the 4-wire fan 503 indicating that the remote fan speed controller 512 has exclusive control of the fan speed of the 4-wire fan 503. After the 20-100 milliseconds has elapsed, the voltage level on the tachometer output wire 550 may be pulled high to receive tachometer output.

Thus, embodiments of a motherboard are described including, a remote fan speed controller 512 coupled with the PWM signal wire 540 and a tachometer signal wire 550 of 4-wire fan 503 via a 4-pin header 510. The motherboard 501 also includes a signal circuit 522 coupled with the tachometer signal wire 550 of 4-wire fan 503 via the 4-pin header. The signal circuit 522 transmits a signal 550a over the tachometer signal wire 550 indicating that the remote fan speed controller 512 has exclusive control over fan speed of the 4-wire fan 503 using the PWM signal wire 540.

In an embodiment, remote fan speed controller 512 provides closed loop feedback control of the 4-wire fan 503 based on fan speed feedback received over tachometer output wire 550.

In an embodiment, signal module 522 provides the signal 550a by applying a logically low voltage to the tachometer output wire 550 for 20-100 milliseconds after operating power has been delivered to the 4-wire fan 503 by motherboard 501.

The 4-wire fan 503 includes a local fan speed controller 513, a thermistor 514 and a determination circuit 523. Local fan speed controller 513 and determination circuit 523 are coupled to the motherboard 501, remote fan speed controller 512 and the signal circuit via the 4 pin header 510.

Thermistor 514 includes material that changes resistivity with temperature. Thermistor 514 is used to sense the ambient temperature at its location on the 4-wire fan 503. Although a thermistor is disclosed in describing embodiments, any suitable temperature sensor known in the art may be used to provide information about ambient temperatures on or around the 4-wire fan 503.

Local fan speed controller 513 variably controls fan speed of the 4-wire fan in an open loop fashion, based on the ambient temperature measured by thermistor 514. Specifically, the local fan speed controller 513 applies a voltage or duty cycle to the fan to cause an RPM corresponding to an ambient temperature measured by thermistor 514.

Determination circuit 523 senses the voltage level on the tachometer output wire 550. The sensing 550b is done for the 20-100 milliseconds after 12V operating voltage 530 has been applied to the 4-wire fan 503. Any electrical circuitry known in the art that conforms to design constraints may be used to sense 550b the voltage on the tachometer output wire 550. A logically low voltage on the tachometer output wire 550 when power is applied to 4-wire fan 503 is an indication from the signal circuit 522 that the remote fan speed controller 512 has exclusive control over the fan speed of the 4-wire fan 503. Accordingly, when the signal is low, determination circuit 523 prevents the local fan speed controller 513 from controlling fan speed by disabling thermistor 514 from providing temperature information to the local fan speed controller 513. A logically high voltage on the tachometer output wire 550 means that a remote fan speed controller 512 will not control 4-wire fan 503. Accordingly, when the signal is high, the determination circuit 523 will allow the local fan speed controller 513 to control the fan speed of the 4-wire fan 503 by enabling thermistor 514 to provide temperature information to the local fan speed controller 513.

Thus, an embodiment of a 4-wire fan 503 is disclosed including, a local fan speed controller 513 controls the fan speed of the 4-wire fan 503 and coupled with a motherboard 501 4-pin fan header. The 4-wire fan also includes a determination circuit 523 capable of being communicatively coupled with the motherboard via the 4-pin header 510 and determines whether the motherboard 501 has exclusive control of fan speed of the 4-wire fan 503.

In an embodiment, determination circuit 523 disables the local fan speed controller 513 from controlling fan speed of the 4-wire fan 503 if the motherboard 501 has been selected to control fan speed of the 4-wire fan 503, and enable the local fan speed controller 513 to control fan speed of the 4-wire fan 503 if the motherboard 501 has not been selected to control fan speed of the 4-wire fan 503.

In an embodiment, determination circuit 523 senses 550b the voltage level on the tachometer output wire 550 for 20-100 milliseconds after operating voltage 530 has been applied to the 4-wire fan 503, determines that the motherboard 501 has exclusive control over fan speed of the 4-wire fan 501 if the voltage level is logically low.

In an embodiment, the 4-wire fan further includes a thermistor 514 communicatively coupled with the determination circuit 523 and the local fan speed controller 513. Thermistor 514 causes a fan speed of the 4-wire fan 503 fan that depends upon the ambient temperature measured by the thermistor 514. In this embodiment, the determination circuit 523 is adapted to disable the thermistor 514 when it is determined that the motherboard 501 has exclusive control of fan speed of the 4-wire fan 503.

Embodiments of the invention described herein may enable lower overall system acoustic levels while still meeting thermal management requirements. Default fan speed control provided by a fan may set a lower limit on fan speed that may be higher than necessary to meet thermal requirements. Motherboards may be able to provide a reduced lower limit on fan speed compared to fan speed control provided by the fan, while still meeting thermal requirements. Embodiments of the invention may enable reduced lower limit on fan speed by disabling default fan speed control provided by the fan. Thus, lower overall system acoustic levels may be realized.

Further, in an embodiment, the configuration operation is transparent to the fan speed control system on the motherboard because fan speed control on the motherboard does not need to be modified due to implementation of embodiments of the invention; it will operate the same way independent of the type of fan it is connected to.

Fans including embodiments of the invention described herein allow for backward compatibility with motherboards that do not include embodiments of the invention. A motherboard not including embodiments of the invention will not generate a signal to the fan (e.g. because the motherboard will immediately pull up the tachometer output of a 4-wire fan to 12V instead of holding it low). Thus, when a fan including embodiments of the invention senses for the signal indicating that the motherboard has control over fan speed of the fan, the signal will not be there, and the fan will enable its own fan speed control (e.g. using a thermistor).

Motherboards including embodiments of the invention described herein allow for backward compatibility with fans that do not include embodiments of the invention. A fan not including embodiments of the invention will not disable its own fan speed control (e.g. by disabling its thermistor) in response to signals from the motherboard. Thus, the fan will share control its fan speed with the motherboard.

Thus, a method and apparatus for automatically configuring control of a fan to be exclusively performed by a motherboard has been disclosed. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. An apparatus comprising:
a remote fan speed control module to be coupled with a fan via a communication medium, and
a signal module to be coupled with the fan via the communication medium to transmit a signal over the communication medium indicating that the remote fan speed control module has exclusive control of fan speed of the fan.

2. The apparatus of claim 1, wherein the remote fan speed control module is operable to provide closed loop feedback control of the fan based on at least one of temperature and fan speed feedback.

3. The apparatus of claim 2, wherein the signal module is operable to provide the signal by applying a logical voltage level to the communication medium for a fixed period of time after operating power has been delivered to the fan.

4. The apparatus of claim 3, wherein the remote fan speed control module is a 4-wire fan pulse width modulation controller to be coupled with a 4-wire fan via a 4-pin fan header, and the signal module includes a resistor-capacitor (RC) delay circuit to provide the signal over a tachometer output of the 4-wire fan.

5. An apparatus comprising:
a fan;,
a local fan speed control module to be coupled with a motherboard via a communication medium and to control the fan speed of the fan; and
a determination module to be coupled with the motherboard via the communication medium and to determine whether the motherboard has exclusive control of fan speed of the fan.

6. The apparatus of claim 5, wherein the determination module to disable the local fan speed control module from controlling fan speed of the fan if the motherboard is selected to control fan speed of the fan, and enable the local fan speed control module to control fan speed of the fan if the motherboard is not selected to control fan speed of the fan.

7. The apparatus of claim 5, wherein the determination module to sense the voltage level on the communication medium for a fixed period of time after operating voltage has been applied to the fan, and to determine that the motherboard has exclusive control of fan speed of the fan based on the voltage level.

8. The apparatus of claim 7, wherein the fan further includes a temperature sensor coupled with the determination module and the local fan speed control module and to cause a fan speed of the fan that depends upon the ambient temperature measured by the temperature sensor, the determination module adapted to disable the temperature sensor when it is determined that the motherboard has exclusive control of fan speed of the fan.

9. The apparatus of claim 8, wherein the fan is a 4-wire fan, the temperature sensor is a thermistor, and the local fan speed control module is a fan speed controller to apply voltage to the fan based on both ambient temperature information from the thermistor and pulse width modulation signals from the motherboard.

10. A method comprising:
generating a signal to indicate to a fan that a motherboard has exclusive control of the fan speed of the fan; and
controlling the fan speed of the fan.

11. The method of claim 10, wherein generating the signal includes maintaining an output of the fan at a voltage level that indicates a first logical level for a fixed period of time after power has been delivered to the fan.

12. The method of claim 10, wherein controlling the fan speed of the fan includes thermally based control and closed loop control based on fan speed feedback.

13. A machine-readable medium containing instructions which, when executed by a processing system, cause the processing system to perform operations, the operations comprising:
generating a signal to indicate to a fan that a motherboard has exclusive control of the fan speed of the fan; and
controlling the fan speed of the fan.

14. The machine readable medium of claim 13, wherein generating the signal includes maintaining an output of the fan at a voltage level that indicates a first logical level for a fixed period of time after power has been delivered to the fan.

15. The machine readable medium of claim 13, wherein controlling the fan speed of the fan includes thermally based control and closed loop control based on fan speed feedback.

16. A method comprising:
receiving a signal from a motherboard; and
determining whether the signal indicates that the motherboard has exclusive control of the fan speed of a fan.

17. The method of claim 16, further comprising:
disabling a local fan speed control module if the motherboard is selected to exclusively control the fan speed of the fan and enabling the local fan speed control module if the motherboard is not selected to exclusively control the fan speed of the fan.

18. The method of claim 16, wherein determining further comprises:
sensing a voltage level at an output of the fan for a fixed period of time after power has been applied to the fan; and
concluding that the motherboard has exclusive control of fan speed of the fan if the voltage level indicates a first logical level and concluding that the motherboard does not have exclusive control of fan speed of the fan if the voltage level indicates a second logical level.

19. A system comprising:
a computer chassis housing at least one motherboard and a plurality of fans,
the at least one motherboard including a remote fan speed control module and a signal module, each coupled with each of the plurality of fans, the signal module to transmit a signal to each of the plurality of fans to indicate that the remote fan speed control module has exclusive control of fan speed of each of the plurality of fans, and
each of the plurality of fans including a local fan speed control module to control fan speed, and a determination module y coupled with the local fan speed control module and the signal module, and to receive the signal from the signal module to determine that the motherboard has exclusive control of fan speed of the one of the plurality of fans.

20. The system of claim 19 wherein the remote fan speed control module to provide thermally based control and closed loop fan speed control based on fan speed feedback, and the local fan speed control module is to provide open loop fan speed control based on temperature measured by a temperature sensor located on each of the plurality of fans.

21. The system of claim 20, wherein the signal module is to apply a voltage level to a communication medium coupled between the signal module and the determination module, the voltage level being held for a fixed period of time after operating power has been applied to the one of the plurality of fans, and the determination module to sense the voltage level on the communication medium during the fixed period of time and to determine that the remote fan speed control module has exclusive control of fan speed of the one of the plurality of fans based on the voltage level.

22. The system of claim 21, wherein the remote fan speed control module is a 4-wire fan pulse width modulation controller, each of the plurality of fans is a 4-wire fan, each temperature sensor is a thermistor, and each local fan speed control module is a local fan speed controller to apply voltage to a fan motor based on ambient temperature information from the thermistor and pulse width modulation signals from the 4-wire fan pulse width modulation controller that is coupled to each of the plurality of 4-wire fans via a 4-pin fan header, and the signal module is a signal circuit including a resistor-capacitor (RC) delay circuit to provide the signal via the tachometer output of the 4-wire fan and the determination module is a determination circuit to sense the signal.
